(19) United States
(12) Patent Application Publication
(10) Pub. No.: US 2023/0411614 A1
(43) Pub. Date: Dec. 21, 2023

(54) ELECTROLYTE ADDITIVE FOR NICKEL-RICH CATHODES AND SILICON-CONTAINING ANODES

(71) Applicant: GM GLOBAL TECHNOLOGY OPERATIONS LLC, Detroit, MI (US)

(72) Inventors: Chuanlong WANG, Ferndale, MI (US); Xiaosong HUANG, Novi, MI (US)

(73) Assignee: GM GLOBAL TECHNOLOGY OPERATIONS LLC, Detroit, MI (US)

(21) Appl. No.: 17/841,250

(22) Filed: Jun. 15, 2022

(51) Int. Cl. H01M 4/525; H01M 4/505; H01M 10/0567; H01M 10/0568; H01M 10/0569

(52) U.S. Cl. CPC H01M 4/525; H01M 4/505; H01M 10/0567; H01M 10/0568; H01M 10/0569; H01M 2004/028

(57) ABSTRACT

An electrochemical cell that cycles lithium ions is provided. The electrochemical cell includes a porous positive electrode that includes a positive electroactive material represented by: LiM¹ₓM²_{y}M³_{z}M⁴_{(1-x-y-z)}O₂, where M¹, M², M³, and M⁴ are transition metals independently selected from the group consisting of: nickel (Ni), manganese (Mn), cobalt (Co), aluminum (Al), iron (Fe), and combinations thereof, 0≤x≤1, 0≤y≤1, and 0≤z≤1. The electrochemical cell also includes a porous negative electrode physically separated from the positive electrode, and an electrolyte disposed in pores of the positive and negative electrodes. The electrolyte may include a lithium salt, an electrolyte additive having one or more alkene amide groups, and a solvent. The negative electrode can include a silicon-based negative electroactive material. The electrolyte additive can be selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes include nickel-rich electroactive materials (e.g., greater than or equal to about 0.6 mole fraction on transition metal lattice), such as NMC (LiNi_{1-x-y}CoₓMn_{y}O₂) (where 0.01≤x≤0.33, 0.01≤y≤0.33) or NCMA (LiNi_{1-x-y-z}CoₓMn_{y}Al_{z}O₂) (where 0.02≤x≤0.20, 0.01≤y≤0.12, 0.01≤z≤0.08), which are capable of providing improved capacity capability (e.g., greater than 200 mAh/g) while allowing for additional lithium extraction without compromising the structural stability of the positive electrode. The negative electrode typically includes a lithium insertion material or an alloy host material. For example, typical electroactive materials for forming an anode include graphite and other forms of carbon, silicon and silicon oxide, tin and tin alloys. Certain anode materials have particular advantages. While graphite having a theoretical specific capacity of 372 mAh·g⁻¹ is most widely used in lithium-ion batteries, anode materials with high specific capacity, for example high specific capacities ranging about 900 mAh·g⁻¹ to about 4,200 mAh·g⁻¹, are of growing interest. For example, silicon has the highest known theoretical capacity for lithium (e.g., about 4,200 mAh·g⁻¹), making it an appealing material for rechargeable lithium ion batteries. Such materials, however, are often susceptible to huge volume expansion during lithiation and delithiation, which can lead to particle pulverization, loss of electrical contact, and unstable solid-electrolyte interface (SEI) formation, causing electrode collapse and capacity fading. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to an electrolyte additive for electrochemical cells that cycle lithium ions, and also, to methods of forming and using the same.

In various aspects, the present disclosure provides a positive electrode for an electrochemical cell that cycles lithium ions. The positive electrode may include a positive electroactive material represented by LiM¹ₓM²_{y}M³_{z}M⁴_{(1-x-y-z)}O₂, where M¹, M², M³, and M⁴ are transition metals independently selected from the group consisting of: nickel (Ni), manganese (Mn), cobalt (Co), aluminum (Al), iron (Fe), and combinations thereof, 0≤x≤1, 0≤y≤1, and 0≤z≤1. The positive electrode may also include an electrolyte that includes a lithium salt, an electrolyte additive having one or more alkene amide groups, and a solvent.

In one aspect, the electrolyte additive may include dimethylacrylamide (DMAA).

In one aspect, the electrolyte additive may be selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

In one aspect, the electrolyte may include greater than or equal to about 0.5 wt. % to less than or equal to about 2 wt. % of the electrolyte additive.

In one aspect, the electrolyte may further include greater than or equal to about 1 wt. % to less than or equal to about 10 wt. % of vinylene carbonate (VC).

In one aspect, the electrolyte may further include greater than or equal to about 1 wt. % to less than or equal to about 10 wt. % of fluoroethylene carbonate (FEC).

In various aspects, the present disclosure provides a negative electrode for an electrochemical cell that cycles lithium ions. The negative electrode may include a silicon-based negative electroactive material, and an electrolyte that includes a lithium salt, an electrolyte additive having one or more alkene amide groups, and a solvent.

In one aspect, the electrolyte additive includes dimethylacrylamide (DMAA).

In one aspect, the electrolyte additive may be selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

In one aspect, the electrolyte may include greater than or equal to about 0.5 wt. % to less than or equal to about 2 wt. % of the electrolyte additive.

In one aspect, the electrolyte may further include greater than or equal to about 1 wt. % to less than or equal to about 10 wt. % of vinylene carbonate (VC).

In one aspect, the electrolyte may further include greater than or equal to about 1 wt. % to less than or equal to about 10 wt. % of fluoroethylene carbonate (FEC).

In various aspects, the present disclosure provides an electrochemical cell that cycles lithium ions. The electrochemical cell may include a porous positive electrode that includes a positive electroactive material represented by: LiM¹_{X}M²_{y}M³_{z}M⁴_{(1-x-y-z)}O₂, where M¹, M², M³, and M⁴ are transition metals independently selected from the group consisting of: nickel (Ni), manganese (Mn), cobalt (Co), aluminum (Al), iron (Fe), and combinations thereof, 0≤x≤1, 0≤y≤1, and 0≤z≤1. The electrochemical cell may also include a porous negative electrode physically separated from the positive electrode, and an electrolyte disposed in pores of the positive and negative electrodes. The electrolyte may include a lithium salt, an electrolyte additive having one or more alkene amide groups, and a solvent.

In one aspect, the positive electroactive material may define a first positive electroactive material, and the positive electrode may further include a second positive electroactive material that is different from the first positive electroactive material. A ratio of the first positive electroactive material to the second positive electroactive material in the positive electrode may be greater than or equal to about 1:9 to less than or equal to about 9:1.

In one aspect, the negative electrode may include a silicon-based negative electroactive material.

In one aspect, the electrolyte additive may include dimethylacrylamide (DMAA).

In one aspect, the electrolyte additive may be selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

In one aspect, the electrolyte may include greater than or equal to about 0.5 wt. % to less than or equal to about 2 wt. % of the electrolyte additive.

In one aspect, the electrolyte may further include greater than or equal to about 1 wt. % to less than or equal to about 10 wt. % of vinylene carbonate (VC).

In one aspect, the electrolyte may further include greater than or equal to about 1 wt. % to less than or equal to about 10 wt. % of fluoroethylene carbonate (FEC).

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell including an electrolyte additive in accordance with various aspects of the present disclosure;

FIG. 2A is a graphical illustration demonstrating discharge capacity versus cycle performance of example cells including electrolyte additives in accordance with various aspects of the present disclosure;

FIG. 2B is a graphical illustration demonstrating capacity retention of the example cells including the electrolyte additives in accordance with various aspects of the present disclosure;

FIG. 2C is a graphical illustration demonstrating the electrochemical impedance of the example cells including the electrolyte additives in accordance with various aspects of the present disclosure;

FIG. 3A is a graphical illustration demonstrating the discharge capacity versus cycle performance of an example cell including an electrolyte additive in accordance with various aspects of the present disclosure; and

FIG. 3B is a graphical illustration demonstrating capacity retention of the example cell including the electrolyte additive in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including an electrolyte additive, and also, to methods of using and forming the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

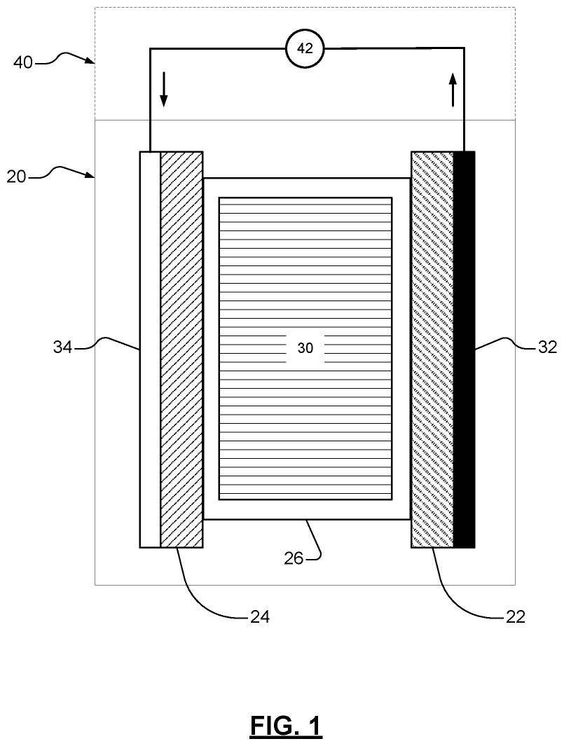

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electrically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electrically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In each variation, however, the electrolyte 30 includes an electrolyte additive that helps to form a stable electrode-electrolyte interphase, for example, by forming a compact and substantially uniform solid electrolyte interphase (SEI) layer, which is insulating to electrons tunneling and conductive for lithium ions, on one or more surfaces of the negative electrode 22 and/or by forming a cathode electrolyte interphase (CEI) layer on one or more surfaces of the positive electrode 24, which helps to mitigate dissolution of nickel (Ni) and manganese (Mn) that often occurs at high voltages. The electrolyte 30 may include greater than 0.5 wt. % to less than or equal to about 2 wt. %, and in certain aspects, optionally greater than 0.75 wt. % to less than or equal to about 1.5 wt. %, of the electrolyte additive. The electrolyte additive may include dimethylacrylamide (DMAA) or other compounds with alkene amide groups, such as N,N-dimethylformamide (DMF), 2,2,2-trifluoro-N, N-dimethylacetamide (FDMA), and/or dimethylacetamide (DMA). In certain variations, the electrolyte 30 may include a first electrolyte additive and a second electrolyte additive. The first electrolyte additive may include dimethylacrylamide (DMAA) or other compounds with alkene amide groups, such as N,N-dimethylformamide (DMF), 2,2,2-trifluoro-N, N-dimethylacetamide (FDMA), and/or dimethylacetamide (DMA). The second electrolyte additive may include fluoroethylene carbonate (FEC) and/or vinylene carbonate (VC).

In certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

In various aspects, the electrolyte 30 may include a mixture of solvents. The electrolyte 30 may include a first solvent, a second solvent, and a third solvent. For example, the electrolyte 30 may include greater than or equal to about 10 wt. % to less than or equal to about 80 wt. %, and in certain aspects, optionally greater than or equal to about 20 wt. % to less than or equal to about 33 wt. %, of a first solvent; greater than or equal to about 10 wt. % to less than or equal to about 80 wt. %, and in certain aspects, optionally greater than or equal to about 20 wt. % to less than or equal to about 33 wt. %, of a second solvent; and greater than or equal to about 10 wt. % to less than or equal to about 80 wt. %, and in certain aspects, optionally greater than or equal to about 20 wt. % to less than or equal to about 33 wt. %, of a third solvent. In certain variations, the solvents may be independently selected from the group consisting of: ethylene carbonate (EC), dimethyl carbonate (DMC), diethyl carbonate (DEC), ethylmethylcarbonate (EMC), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 μm to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. The solid electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3-x}TiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electrode 24 may be a nickel-rich cathode including a positive electroactive material represented by:

LiM¹ₓM²_{y}M³_{z}M⁴_{(1-x-y-z)}O₂

where M1, M2, M3, and M4 are transitions metals (for example, independently selected from the group consisting of: nickel (Ni), manganese (Mn), cobalt (Co), aluminum (Al), iron (Fe), and combinations thereof), 0≤x≤1, 0≤y≤1, and 0≤z≤1. For example, the positive electrode 24 may include NMC (LiNi_{1-x-y}CoₓMn_{y}O₂) (where 0.10≤x≤0.33, 0.10≤y≤0.33) or NCMA (LiNi_{1-x-y-z}CoₓMn_{y}Al_{z}O₂) (where 0.02≤x≤0.20, 0.01≤y≤0.12, 0.01≤z≤0.08). The positive electrode 24 may include NCM 111, NCM 532, NCM 622, NCM 712, NCM 811, NCMA, NCA, LNMO, and combinations thereof.

In other variations, the positive electrode 24 may include one or more positive electroactive materials having a spinel structure (such as, lithium manganese oxide (Li₍₁₊ₓ₎Mn₂O₄, where 0.1≤x≤1) (LMO) and/or lithium manganese nickel oxide (LiMn₍₂₋ₓ₎Ni_{X}O₄, where 0≤x≤0.5) (LNMO) (e.g., LiMn_{1.5}Ni_{0.5}O₄)); one or more materials with a layered structure (such as, lithium cobalt oxide (LiCoO₂) (LCO)); and/or a lithium iron polyanion oxide with olivine structure (such as, lithium iron phosphate (LiFePO₄) (LFP), lithium manganese-iron phosphate (LiMn₂₋ₓFeₓPO₄, where 0≤x≤0.3) (LMFP), and/or lithium iron fluorophosphate (Li₂FePO₄F)).

In still other variations, the positive electrode 24 may be a composite electrode including two or more positive electroactive material. For example, the positive electrode 24 may include a first positive electroactive material and a second positive electroactive material. In certain variations, a ratio of the first positive electroactive material to the second positive electroactive material may be greater than or equal to about 1:9 to less than or equal to about 9:1. The first positive electroactive material may include the nickel-rich positive electroactive material. The second positive electroactive material may include, for example, a layered oxide represented by LiMeO₂, where Me is a transition metal, such as cobalt (Co), nickel (Ni), manganese (Mn), iron (Fe), aluminum (Al), vanadium (V), or combinations thereof; an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; and/or a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

In each variation, the positive electroactive material may be optionally intermingled (e.g., slurry casted) with an electronically conductive material that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polytetrafluoroethylene (PTFE) copolymers, polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 includes a silicon-based electroactive material, including, for example lithium-silicon, silicon containing binary and ternary alloys, and/or tin-containing alloys (such as, Si, Li—Si, SiOₓ (where 0≤x≤2), lithium doped SiOₓ (where 0≤x≤2), Si—Sn, SiSnFe, SiSnAl, SiFeCo, SnO₂, and the like). In other variations, the negative electrode 22 includes one or more other volume-expanding materials (e.g., aluminum, germanium, tin). In still other variations, the negative electrode 22 may be a composite electrode including two or more negative electroactive materials. For example, the negative electrode 22 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon) For example, in certain variations, the negative electroactive material may include a carbonaceous-silicon based composite including, for example, about 10 wt. % SiOₓ (where 0≤x≤2) and about 90 wt. % graphite. In still further variations, the negative electroactive material may include a carbon coated silicon. In each variation, as would be recognized by the skilled artisan, the negative electroactive material may be prelithiated.

In certain variations, the negative electroactive material may be optionally intermingled (e.g., slurry casted) with an electronically conductive material that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The electronically conducting material and/or polymeric binder as included in the negative electrode 22 may be the same as or different from the electronically conducting material and/or polymeric binder as included in the positive electrode 24.

Certain features of the current technology are further illustrated in the following non-limiting examples.

### Example 1

Example batteries and battery cells may be prepared in accordance with various aspects of the present disclosure. For example, a first example cell 310 may include a first example electrolyte comprising 1 wt. % of dimethylacrylamide (DMAA) disposed with, for example, 1M lithium hexafluorophosphate (LiPF₆) in a solvent mixture comprising, for example, 3 ethylene carbonate (EC):7 dimethyl carbonate (DMC). A second example cell 320 may include a second example electrolyte comprising 1 wt. % of dimethylacrylamide (DMAA), 1 wt. % vinylene carbonate (VC), and 2 wt. % of fluoroethylene carbonate (FEC) disposed with, for example, 1M lithium hexafluorophosphate (LiPF₆) in a solvent mixture comprising, for example, 3 ethylene carbonate (EC):7 dimethyl carbonate (DMC). A first comparative cell 330 may include a first comparative electrolyte comprising 1 wt. % vinylene carbonate (VC), and 2 wt. % of fluoroethylene carbonate (FEC) disposed with, for example, 1M lithium hexafluorophosphate (LiPF₆) in a solvent mixture comprising, for example, 3 ethylene carbonate (EC):7 dimethyl carbonate (DMC). A second comparative cell 340 may include 1M lithium hexafluorophosphate (LiPF₆) in a solvent mixture comprising, for example, 3 ethylene carbonate (EC):7 dimethyl carbonate (DMC). The following table compares the example electrolytes.

Electrolyte

| Cell | Additive | Salt | Solvent |
|---|---|---|---|
| 310 | 1 wt. % DMAA | 1M LiPF₆ | EM:DMC (3:7) |
| 320 | 1 wt. % DMAA | 1M LiPF₆ | EM:DMC (3:7) |
| | | | 1 wt. % VC |
| | | | 2 wt. % FEC |
| 330 | — | 1M LiPF₆ | EM:DMC (3:7) |
| | | | 1 wt. % VC |
| | | | 2 wt. % FEC |
| 340 | — | 1M LiPF₆ | EM:DMC (3:7) |

Each of the cells 310, 320, 330, 340 may include an anode including a negative electroactive material comprising silicon oxide (SiOₓ, where 1≤x≤2) and graphite, and a cathode including a positive electroactive material comprising NCMA (LiNi_{1-x-y-z}CoₓMn_{y}Al_{z}O₂) (where 0.02≤x≤0.20, 0.01≤y≤0.12, 0.01≤z≤0.08). The anode may also include, for example, a first polymeric binder (e.g., carboxymethyl cellulose (CMC) and/or styrene-butadiene rubber (SBR)) and a first conductive additive (e.g., SuperP). The cathode may also include, for example, a second polymeric binder (e.g., polyvinylidene fluoride (PVdF)) and a second conductive additive (e.g., SuperP, graphene platelets (GNP), and/or carbon nanotubes (CNT). The cathode may have a capacity of about 5.0 mAh/cm².

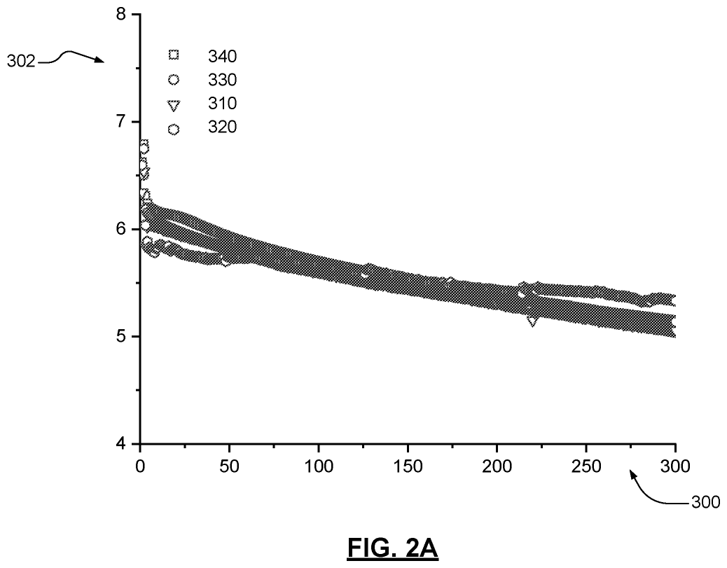

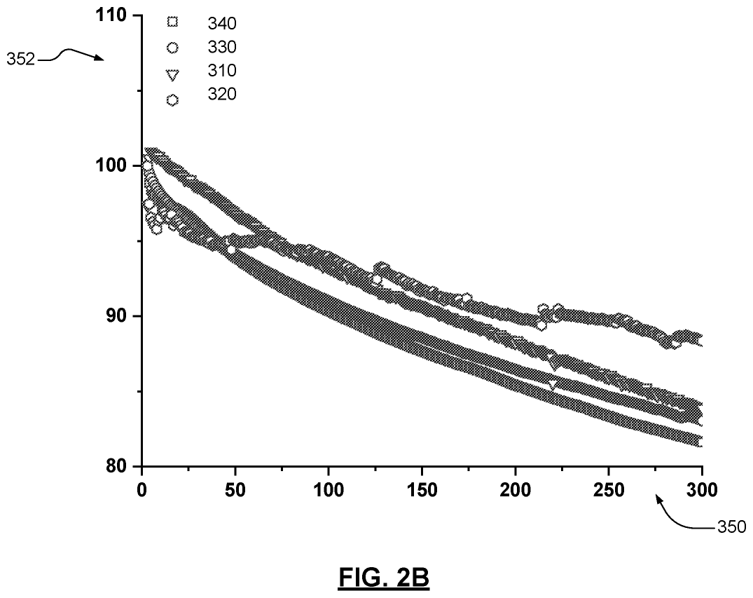

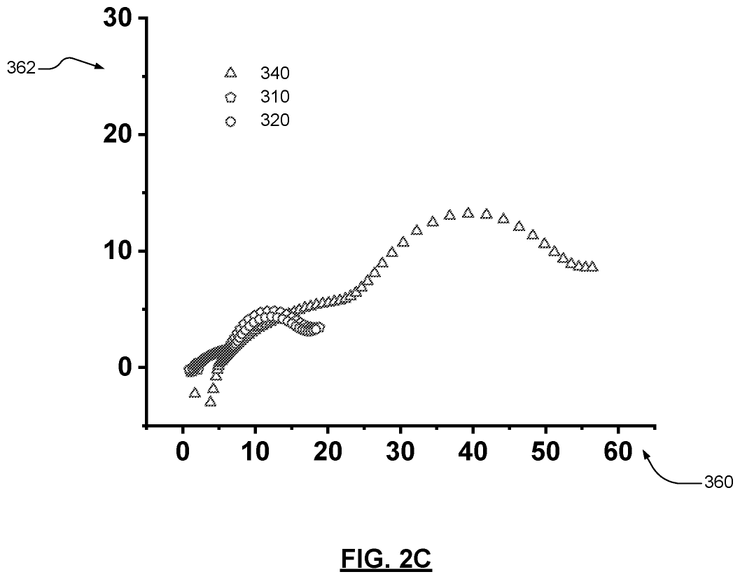

FIG. 2A is a graphical illustration demonstrating the cell capacity verse cycle performance of the example cells 310, 320 as compared to the comparative cells 330, 340, where the x-axis 300 represents cycle number, and the y-axis 302 represents capacity (mAh). As illustrated, the example cells 310, 320 have similar capacity delivery during cycling.

FIG. 2B is a graphical illustration demonstrating capacity retention of the example cells 310, 320 as compared to the comparative cells 330, 340, where the x-axis 350 represents cycle number, and the y-axis 352 represents capacity retention (%). As illustrated, the example cells 310, 320 has improved capacity retention over cycling.

FIG. 2C is a graphical illustration demonstrating the electrochemical impedance (for example, after three formation cycles (C/20) at 4.2 V) of the example cells 310, 320 as compared to the comparative cell 340, where the x-axis 360 represents Z′ (Ohm), and the y-axis 362 represents Z″ (Ohm). As illustrated, the inclusion of dimethylacrylamide (DMAA) reduces cell impedance.

### Example 2

Example batteries and battery cells may be prepared in accordance with various aspects of the present disclosure. For example, an example cell 410 may include a first example electrolyte comprising 1 wt. % of dimethylacrylamide (DMAA) disposed with, for example, 1M lithium hexafluorophosphate (LiPF₆) in a solvent mixture comprising, for example, 3 ethylene carbonate (EC):7 dimethyl carbonate (DMC). A comparative cell 420 may include 1M lithium hexafluorophosphate (LiPF₆) in a solvent mixture comprising, for example, 3 ethylene carbonate (EC):7 dimethyl carbonate (DMC).

Both the example cell 410 and the comparative cell 420 include an anode including a negative electroactive material comprising a lithiated silicon oxide (LiₓSiO_{y}, where 1≤x≤8 and 2.5≤y≤6) and graphite, and a cathode including a positive electroactive material comprising NCMA (LiNi_{1-x-y-z}CoₓMn_{y}Al_{z}O₂) (where 0.02≤x≤0.20, 0.01≤y≤0.12, 0.01≤z≤0.08). The anode may also include, for example, a first polymeric binder (e.g., carboxymethyl cellulose (CMC) and/or styrene-butadiene rubber (SBR)) and a first conductive additive (e.g., SuperP and/or carbon nanotubes (CNT)). The cathode may also include, for example, a second polymeric binder (e.g., polyvinylidene fluoride (PVdF)) and a second conductive additive (e.g., SuperP and/or graphene platelets (GNP) and/or carbon nanotubes (CNT). The cathode may have a loading of about 5.0 mAh/cm².

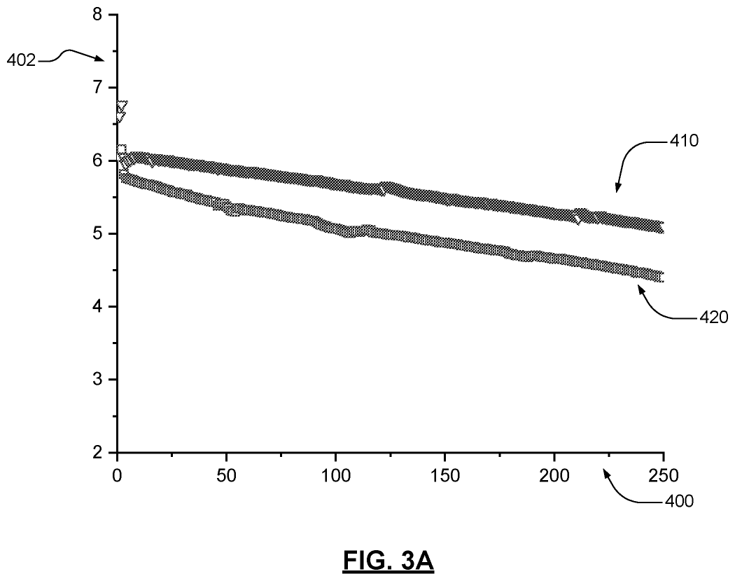

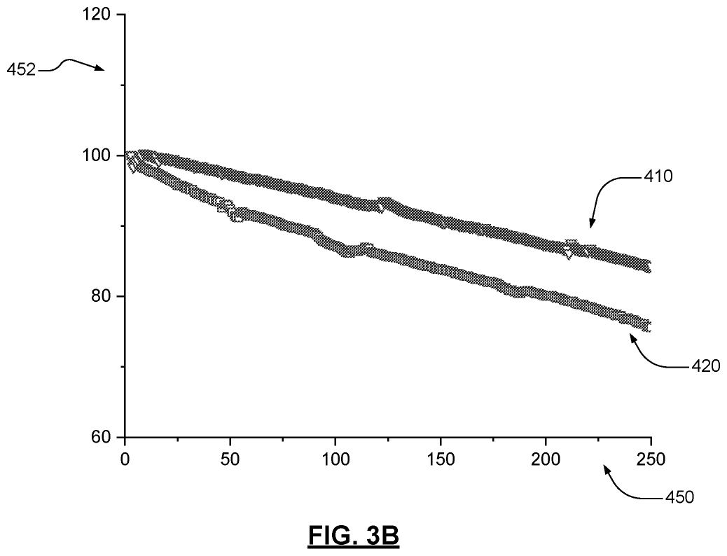

FIG. 3A is a graphical illustration demonstrating the cell capacity verses cycling performance of the example cell 410 as compared to the comparative cell 420, where the x-axis 400 represents cycle number, and the y-axis 402 represents capacity (mAh). As illustrated, the example cell 410 has a higher average capacity.

FIG. 3B is a graphical illustration demonstrating the capacity retention of the example cell 410 as compared to the comparative cell 420, where the x-axis 450 represents cycle number, and the y-axis 452 represents capacity retention (%). As illustrated, the example cell 410 has improved capacity retention over cycling.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A positive electrode for an electrochemical cell that cycles lithium ions, the positive electrode comprising:
a positive electroactive material represented by:
LiM¹ₓM²_{y}M³_{z}M⁴_{(1-x-y-z)}O₂
where M¹, M², M³, and M⁴ are transition metals independently selected from the group consisting of: nickel (Ni), manganese (Mn), cobalt (Co), aluminum (Al), iron (Fe), and combinations thereof, 0≤x≤1, 0≤y≤1, and 0≤z≤1; and
an electrolyte comprising a lithium salt, an electrolyte additive having one or more alkene amide groups, and a solvent.

2. The positive electrode of claim 1, wherein the electrolyte additive comprises dimethylacrylamide (DMAA).

3. The positive electrode of claim 1, wherein the electrolyte additive is selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

4. The positive electrode of claim 1, wherein the electrolyte comprises greater than or equal to about 0.5 wt. % to less than or equal to about 2 wt. % of the electrolyte additive.

5. The positive electrode of claim 1, wherein the electrolyte further comprises:
greater than or equal to about 1 wt. % to less than or equal to about 10 wt. % of vinylene carbonate (VC).

6. The positive electrode of claim 1, wherein the electrolyte further comprises:
greater than or equal to about 1 wt. % to less than or equal to about 10 wt. % of fluoroethylene carbonate (FEC).

7. A negative electrode for an electrochemical cell that cycles lithium ions, the negative electrode comprising:
a silicon-based negative electroactive material; and
an electrolyte comprising a lithium salt, an electrolyte additive having one or more alkene amide groups, and a solvent.

8. The negative electrode of claim 7, wherein the electrolyte additive comprises dimethylacrylamide (DMAA).

9. The negative electrode of claim 7, wherein the electrolyte additive is selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

10. The negative electrode of claim 7, wherein the electrolyte comprises greater than or equal to about 0.5 wt. % to less than or equal to about 2 wt. % of the electrolyte additive.

11. The negative electrode of claim 7, wherein the electrolyte further comprises:
greater than or equal to about 1 wt. % to less than or equal to about 10 wt. % of vinylene carbonate (VC).

12. The negative electrode of claim 7, wherein the electrolyte further comprises:
greater than or equal to about 1 wt. % to less than or equal to about 10 wt. % of fluoroethylene carbonate (FEC).

13. An electrochemical cell that cycles lithium ions, the electrochemical cell comprising:
a porous positive electrode comprising a positive electroactive material represented by:
LiM¹ₓM²_{y}M³_{z}M⁴_{(1-x-y-z)}O₂
where M¹, M², M³, and M⁴ are transition metals independently selected from the group consisting of: nickel (Ni), manganese (Mn), cobalt (Co), aluminum (Al), iron (Fe), and combinations thereof, 0≤x≤1, 0≤y≤1, and 0≤z≤1;
a porous negative electrode physically separated from the positive electrode; and
an electrolyte disposed in pores of the positive and negative electrodes, the electrolyte comprising a lithium salt, an electrolyte additive having one or more alkene amide groups, and a solvent.

14. The electrochemical cell of claim 13, wherein the positive electroactive material defines a first positive electroactive material, and the positive electrode further comprises a second positive electroactive material that is different from the first positive electroactive material, a ratio of the first positive electroactive material to the second positive electroactive material in the positive electrode being greater than or equal to about 1:9 to less than or equal to about 9:1.

15. The electrochemical cell of claim 13, wherein the negative electrode comprises a silicon-based negative electroactive material.

16. The electrochemical cell of claim 13, wherein the electrolyte additive comprises dimethylacrylamide (DMAA).

17. The electrochemical cell of claim 13, wherein the electrolyte additive is selected from the group consisting of: dimethylacrylamide (DMAA), N,N-dimethylformamide (DMF), 2,2,2-trifluoro-N, N-dimethylacetamide (FDMA), dimethylacetamide (DMA), and combinations thereof.

18. The electrochemical cell of claim 13, wherein the electrolyte comprises greater than or equal to about 0.5 wt. % to less than or equal to about 2 wt. % of the electrolyte additive.

19. The electrochemical cell of claim 13, wherein the electrolyte further comprises:
greater than or equal to about 1 wt. % to less than or equal to about 10 wt. % of vinylene carbonate (VC).

20. The electrochemical cell of claim 13, wherein the electrolyte further comprises:
greater than or equal to about 1 wt. % to less than or equal to about 10 wt. % of fluoroethylene carbonate (FEC).
